(19) United States
(12) Patent Application Publication
(10) Pub. No.: US 2002/0124266 A1
(43) Pub. Date: Sep. 5, 2002

(54) Method and device for remote access of a power control system of a set-top box

(76) Inventor: Robert Blanchard, Escondido, CA (US)

Correspondence Address: WAGNER, MURABITO & HAO LLP, Two North Market Street, Third Floor, San Jose, CA, 95113, US

(21) Appl. No.: 09/799,482

(22) Filed: Mar. 5, 2001

(51) Int. Cl. H04N 7/173; H04N 7/16

(52) U.S. Cl. 725/130; 725/152; 725/139; 725/131

(57) ABSTRACT

A method and device for remote access of power control system of a set-top box allowing for a cable or satellite operator to activate the main power supply of a cable box from a remote location. An externally generated signal is received at the set-top box in standby mode. In one embodiment, if the externally generated signal requires decoding, the externally generated signal is then decoded to determine whether it is for activating the main power supply. If the externally generated signal is for activating said main power supply, the main power supply is activated, placing the set-top box in active mode. Activating the main power supply operates to provide power to the main circuitry. In one embodiment, once the main circuitry is provided with power, the set-top box can receive externally generated information, such as program information and emergency alerts. In another embodiment, once the set-top box is done receiving the externally generated information, the set-top box determines whether a user has interacted with the set-top box since the main circuitry has been activated. If there has been no user interaction with the set-top box since the main circuitry has been activated, the main power supply is deactivated, returning the set-top box to standby mode.

### FIELD OF INVENTION

The present invention relates to the field of cable and satellite television. In particular, the present invention relates to remote access of the power control system operating in set-top boxes.

### BACKGROUND OF THE INVENTION

Television has become a part of the everyday lives of people all over the world. With the advent of cable, and later satellite, broadcasting systems, television viewers are provided with an increasingly large number of television channels from which to choose. Hence, cable and satellite systems have become increasingly popular, and their use is widespread. In order to provide service, most cable and satellite broadcast systems utilize set-top boxes to receive and decode broadcast signals. Set-top boxes are coupled to televisions and enable the viewer to view the received broadcast signals.

Presently, most set-top boxes require a significant amount of power to operate (e.g. 50-60 watts). Even upon turning a set-top box off, the power used rarely decreases more than a few watts. Essentially, the power consumed by the set-top box is relatively constant, and turning the power off has a minor effect on the power consumed. This is a result of the current system architecture in most set-top boxes which keeps the main circuitry of the set-top box activated at all times.

Under current system architecture, cable and satellite providers require that set-top boxes maintain near to full power usage so that they can access the main circuitry of set-top boxes from remote locations. Cable and satellite providers require access to the main circuitry of set-top boxes for a variety of reasons, such as performing system maintenance, initialization, activation, software downloads, program information downloads, emergency alerts, and polling the set-top boxes to ensure that they are in the correct location. Presently, set-top boxes must be operating at near to full power to enable the main circuitry to be accessed by cable and satellite providers.

Recently, the Environmental Protection Agency (EPA) began to insist that producers of set-top boxes develop a lower power mode such that upon activating the lower power mode, the set-top box consumes substantially less power than when it is in regular power mode (e.g. less than 5 watts). However, as cable and satellite providers require that set-top boxes maintain near to full power, current system architectures cannot accommodate the new EPA requirements.

### SUMMARY OF THE INVENTION

Accordingly, a need exists for a method and a device thereof for permitting a set-top box to operate in a low power mode. A need also exists for a method and a device thereof that accomplishes the above need and permits cable and satellite operators to activate the main power supply of set-top box from a remote location, permitting them to access the main circuitry of the set-top box at any time they need to.

A method and device are discussed for remote access of power control system of a set-top box allowing for a cable or satellite operator to activate the main power supply of a cable box from a remote location. An externally generated signal is received at the set-top box operating in standby mode. The set-top box includes a receiving unit coupled to a standby power supply. The standby power supply provides sufficient power to the receiving unit for operation when the main power supply is not active. If the externally generated signal is for activating said main power supply, the main power supply is activated, placing the set-top box in active mode. Activating the main power supply operates to provide power to the main circuitry.

In one embodiment, the externally generated signal requires decoding wherein the set-top box also comprises a decoding unit. The decoding unit is coupled to the standby power supply. The standby power supply provides sufficient power to the decoding unit for operation when the main power supply is not active. In the present embodiment, upon receiving an externally generated signal, the externally generated signal is then decoded to determine whether it is for activating the main power supply. If the externally generated signal is for activating said main power supply, the main power supply is activated, placing the set-top box in active mode. Activating the main power supply operates to provide power to the main circuitry.

In one embodiment, once the main circuitry is activated, the set-top box can receive externally generated information such as software downloads for system maintenance, program information and emergency alerts. In another embodiment, once the main circuitry is activated, the cable or satellite provider is able to poll the set-top boxes to ensure that they are in the correct location.

In another embodiment, once the set-top box is done receiving the externally generated information, the set-top box determines whether a user has interacted with the set-top box since the main circuitry has been activated. If there has been no user interaction with the set-top box since the main circuitry has been activated, the main power supply is deactivated, returning the set-top box to standby mode. If there has been user interaction with the set-top box (e.g. a user has begun to watch television), the main power supply remains activated so as to allow for uninterrupted viewing.

The present invention provides for a method and a device thereof for permitting a set-top box to operate in a low power mode. The present invention also provides for a method and a device thereof that permits cable and satellite operators to activate the main power supply of set-top box from a remote location, permitting them to access the main circuitry of the set-top box. Thus, the present invention provides for a system and a device thereof that permits set-top box manufacturers to manufacture set-top boxes that satisfy both the requirements of the EPA and the requirements of cable and satellite providers.

These and other objects and advantages of the present invention will become obvious to those of ordinary skill in the art after having read the following detailed description of the preferred embodiments which are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram showing a typical home network of consumer electronic devices for receiving and viewing broadcast signals in accordance with one embodiment of the present invention.

FIG. 2 is a block diagram of one embodiment of a set-top box configured for activation from a remote location in accordance with the present invention.

FIG. 3 is a flowchart showing the steps in a process for remote access of the power control system of a set-top box in accordance with one embodiment of the present invention.

FIG. 4 is a block diagram of one embodiment of a set-top box comprising a decoding element configured for activation from a remote location in accordance with the present invention.

FIG. 5 is a flow chart showing the steps in a process for remote access of the power control system of a set-top box comprising a decoding unit in accordance with one embodiment of the present invention.

### DETAILED DESCRIPTION OF THE INVENTION

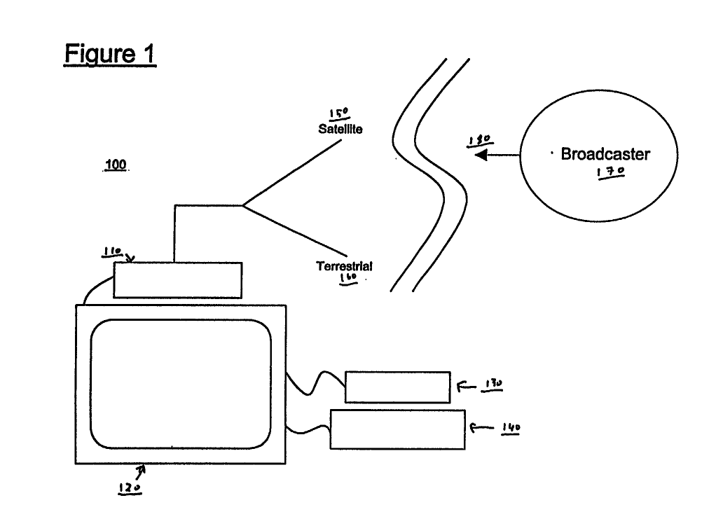

FIG. 1 is a block diagram showing a typical home entertainment network 100 of consumer electronic devices for receiving and viewing broadcast signals in accordance with one embodiment of the present invention. Set-top box 110 is coupled to television 120. Consumer electronic devices 130 and 140 are coupled to one or both of set-top box 110 and television 120. Consumer electronic devices 130 and 140 are typical devices used in a home entertainment network, including, but not limited to, the following: video cassette recorder (VCR), home stereo receiver, digital video disc (DVD) player, camcorder, and digital camera. It should be appreciated that there may be any number of these devices, or none of these devices; consumer electronic devices 130 and 140 are shown for exemplary purposes only.

Set-top box 110 receives broadcast signal 180 that is transmitted by broadcaster 170. Set-top box 110 is configured to display broadcast signal 180 on television 120 for viewing. Broadcaster 170 is a cable or satellite broadcast provider. It should be appreciated that broadcaster 170 can be any broadcast signal provider, and is not limited to only cable and satellite services.

Broadcaster 170 transmits broadcast signal 180 to set-top box 110 over satellite connection 150 or terrestrial connection 160. Terrestrial connection 160 is appreciated to include coaxial cable connections. It should be further appreciated that Broadcaster 170 may transmit broadcast signals and other signals over standard telephone lines and power lines, so long as they are coupled to set-top box 110 and set-top box 110 is configured for receiving signals over telephone lines or power lines.

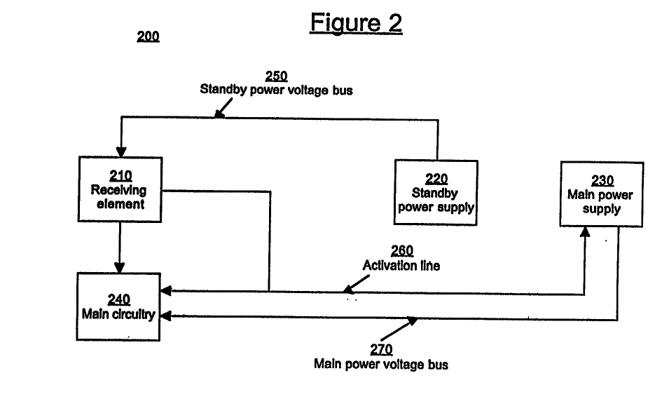

FIG. 2 is a block diagram of one embodiment of a set-top box 200 configured for activation from a remote location in accordance with the present invention. Set-top box 200 is configured to receive broadcast and other externally generated signals from a cable or satellite provider (e.g. broadcaster 170 of FIG. 1) at receiving element 210 over broadcast channels and out-of-band channels. In one embodiment, receiving element 210 is a radio frequency input amplifier. In another embodiment, receiving element 210 is configured to receive signals over a terrestrial connection (e.g. coaxial cable). In another embodiment, receiving element 210 is configured to receive signals over a satellite connection. In another embodiment, receiving element 210 is configured to receive signals over a telephone line. In another embodiment, receiving element 210 is configured to receive signals over a power line.

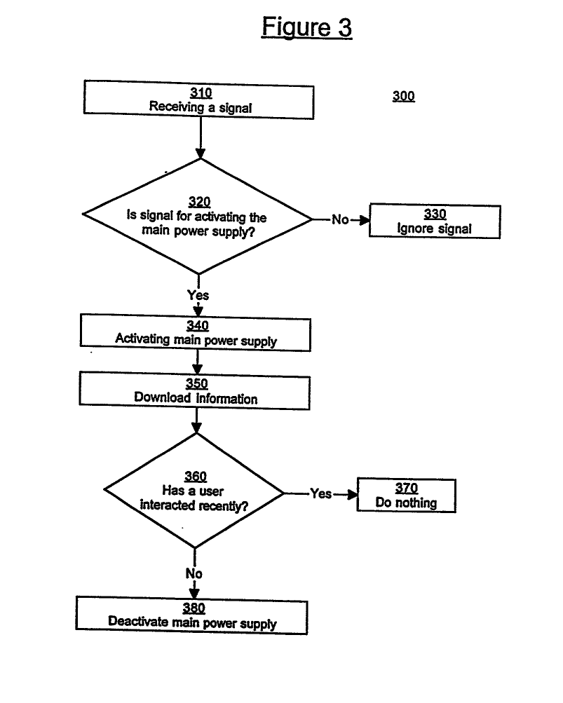

Set-top box 200 operates in two power modes, an “active” mode and a “standby” mode. In one embodiment, set-top box 200 is configured to perform a process for remote access of the power control system of a set-top box (e.g. configured to perform process 300 of FIG. 3).

When set-top box 200 is in active mode, main power supply 230 provides power to main circuitry 240 over main power voltage bus 270. In one embodiment, when set-top box 200 is in active mode, main power supply 230 also provides power to receiving element 210. In this embodiment, standby power supply 220 is inactive when main power supply 230 is active and standby power supply 220 is active when main power supply 230 is inactive.

When set-top box 200 is in active mode, a user may interact with set-top box 200 (e.g. watch television). Also, when set-top box 200 is in active mode, a cable or satellite provider may interact with main circuitry 240. The cable or satellite provider might transmit signals to perform system maintenance, software downloads, and program information downloads. Also, the cable or satellite provider may transmit emergency messages or poll the set-top box. Polling is a process by which a provider can check the physical location of a specific set-top box to ensure that it is in the proper location.

Conversely, when set-top box 200 is in standby mode, standby power supply 220 provides power to receiving element 210 over standby voltage bus 250. It should be appreciated that standby power supply 220 provides substantially less power than main power supply 230, and only provides power to receiving element 210. When in standby power mode, main circuitry 240 is not active. Therefore, a cable or satellite provider is unable to interact with main circuitry 240.

When operating in standby mode, only receiving element 210 is active. While receiving element 210 may receive any number of signals over broadcast and out-of-band channels, when operating in standby mode, receiving element 210 can only detect signals transmitted for the purpose of activating main power supply 230.

Upon receiving a signal from the cable or satellite provider to activate main power supply 230, receiving element 210 will send an activation signal along activation line 260 to main power supply 230. This activation signal operates to activate main power supply 230. Upon receiving the activation signal, main power supply 230 is activated. Hence, set-top box switches from standby power mode to active power mode.

In one embodiment, receiving element 210 also sends an activation signal along activation line 260 to main circuitry 240. In the present embodiment, system architecture may require an activation signal in addition to power to activate main circuitry 240. Upon receiving both the activation signal and power from main power supply 230, main circuitry 240 is activated. Hence, set-top box switches from standby power mode to active power mode.

As described above, a cable or satellite provider can interact with main circuitry 240 when set-top box 200 is in active mode. Receiving element 210 is coupled to main circuitry 240 over a connection for transmitting electron data (e.g. a wire). Receiving element 210 receives externally generated information (e.g. software downloads, polling requests) and transmits the information to main circuitry 240. Upon receiving the information, main circuitry interprets the information and allocates it or responds to it as desired.

Upon the completion of receiving externally generated information, main circuitry 240 determines whether or not a user has interacted (e.g. began to watch television, changed channels, adjusted the volume) with set-top box 200 in the period between the set-top box entering active mode and the completion of receiving the information. If a user has not interacted with set-top box 200, main circuitry 240 sends a deactivation signal to main power supply 240. Upon receiving the deactivation signal, main power supply 240 deactivates, returning set-top box 200 to standby mode. Conversely, if a user has interacted with set-top box 200, main circuitry 240 does not send a deactivation signal so as not to interrupt the user's viewing.

FIG. 3 is a flowchart showing the steps in a process 300 for remote access of the power control system of a set-top box (e.g. set-top box 200 of FIG. 2) in accordance with one embodiment of the present invention. The set-top box is configured for receiving broadcast signals and other externally generated signals transmitted by a cable or satellite provider over broadcast channels and out-of-band channels. The set-top box operates in two power modes, an “active” mode and a “standby” mode.

At step 310 of process 300, the set-top box receives a signal from a cable or satellite provider. In one embodiment, the signal is received at a receiving element (e.g. receiving element 210 of FIG. 2). In one embodiment, the receiving element is a radio frequency input amplifier. In another embodiment, the receiving element is configured to receive signals over a terrestrial connection (e.g. coaxial cable). In another embodiment, the receiving element is configured to receive signals over a satellite connection. In another embodiment, the receiving element is configured to receive signals over a telephone line. In another embodiment, the receiving element is configured to receive signals over a power line.

The receiving element is coupled to a standby power supply. When the set-top box is operating in standby mode, the standby power supply operates to provide sufficient power to the receiving element.

At step 320, it is determined whether the signal is for the purpose of activating the main power supply of the set-top box. If the signal is not for activating the main power supply of the set-top box, as shown at step 330 or process 300, the signal is ignored. Inversely, if the signal is for the activating the main power supply, as shown at step 340, the main power supply is activated. Upon activating the main power supply, the main circuitry becomes active.

In one embodiment, the receiving element will send an activation signal to the main power supply. This activation signal operates to activate main power supply. Upon receiving the activation signal, the main power supply is activated. Hence, the set-top box switches from standby power mode to active power mode.

In another embodiment, the decoding element sends an activation signal to both the main power supply and the main circuitry. In the present embodiment, system architecture may require an activation signal in addition to power to activate the main circuitry. Upon receiving both the activation signal and power from the main power supply, the main circuitry is activated. Hence, the set-top box switches from standby power mode to active power mode.

At step 350 of process 300, the cable or satellite provider interacts with the main circuitry. When the set-top box is operating in active mode, the cable or satellite operator will transmit externally generated information to the main circuitry. The cable or satellite provider might transmit signals to perform system maintenance, software downloads, and program information downloads. Also, the cable or satellite provider may transmit emergency messages or poll the set-top box. Polling is a process by which a provider can check the physical location of a specific set-top box to ensure that it is in the proper location.

Upon the completion of receiving externally generated information, as shown at step 360, the main circuitry determines whether a user has user has interacted (e.g. began to watch television, changed channels, adjusted the volume) with set-top box in the period between the set-top box entering active mode and the completion of receiving the information.

If a user has not interacted with the set-top box, as shown at step 380, the main power supply deactivates, returning the set-top box to standby mode. Conversely, if a user has interacted with the set-top box, as shown at step 370, the main power supply remains active so as not to interrupt the user's viewing.

Thus, the present invention provides for a method and a device for permitting a set-top box to operate in a low power mode. The present invention also provides for a method and a device that permits cable and satellite operators to activate the main power supply of set-top box from a remote location, permitting them to access the main circuitry of the set-top box. Thus, the present invention provides for a system and a device that permits set-top box manufacturers to manufacture set-top boxes that satisfy both the requirements of the EPA and the requirements of cable and satellite providers.

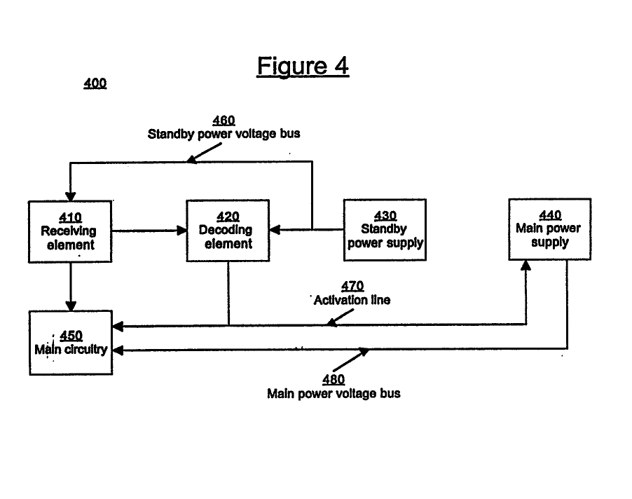

FIG. 4 is a block diagram of one embodiment of a set-top box 400 configured for activation from a remote location in accordance with the present invention. Set-top box 400 is configured to receive broadcast and other externally generated signals from a cable or satellite provider (e.g. broadcaster 170 of FIG. 1) at receiving element 410 over broadcast channels and out-of-band channels. In one embodiment, receiving element 410 is a radio frequency input amplifier. In another embodiment, receiving element 410 is configured to receive signals over a terrestrial connection (e.g. coaxial cable). In another embodiment, receiving element 410 is configured to receive signals over a satellite connection. In another embodiment, receiving element 410 is configured to receive signals over a telephone line. In another embodiment, receiving element 410 is configured to receive signals over a power line.

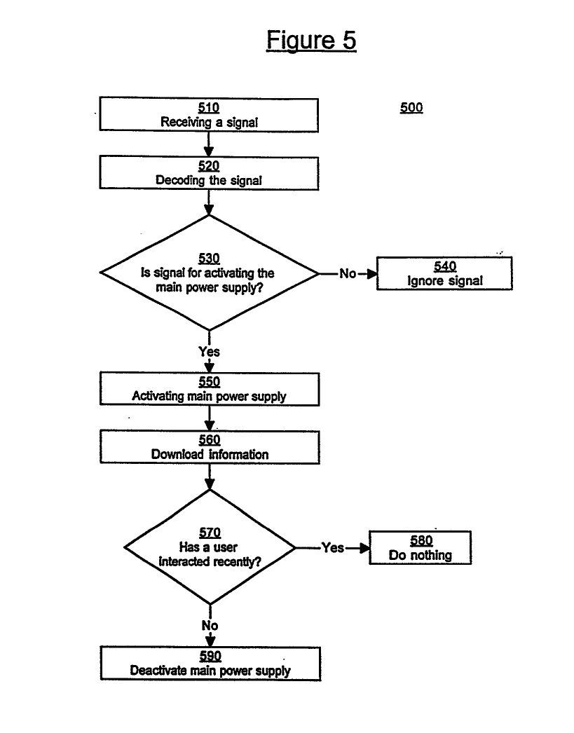

Set-top box 400 operates in two power modes, an “active” mode and a “standby” mode. In one embodiment, set-top box 400 is configured to perform a process for remote access of the power control system of a set-top box (e.g. configured to perform process 500 of FIG. 5).

When set-top box 400 is in active mode, main power supply 440 provides power to main circuitry 450 over main power voltage bus 480. In one embodiment, when set-top box 400 is in active mode, main power supply 440 also provides power to receiving element 410 and decoding element 420. In this embodiment, standby power supply 430 is inactive when main power supply 440 is active and standby power supply 430 is active when main power supply 440 is inactive.

When set-top box 400 is in active mode, a user may interact with set-top box 400 (e.g. watch television). Also, when set-top box 400 is in active mode, a cable or satellite provider may interact with main circuitry 450. The cable or satellite provider might transmit signals to perform system maintenance, software downloads, and program information downloads. Also, the cable or satellite provider may transmit emergency messages or poll the set-top box. Polling is a process by which a provider can check the physical location of a specific set-top box to ensure that it is in the proper location.

Conversely, when set-top box 400 is in standby mode, standby power supply 430 provides power to receiving element 410 and decoding element 420 over standby voltage bus 460. It should be appreciated that standby power supply 430 provides substantially less power than main power supply 440, and only provides power to receiving element 410 and decoding element 420. When in standby power mode, main circuitry 450 is not active. Therefore, a cable or satellite provider is unable to interact with main circuitry 450.

When operating in standby mode, only receiving element 410 and decoding element 420 are active. In standby mode, receiving element 410 may receive any number of signals over broadcast and out-of-band channels at receiving element 410. In one embodiment, the cable or satellite provider will transmit a signal for activating main power supply 440. This signal can take any form, and can be transmitted over any broadcast or out-of-band channel. In one embodiment, the signal for activating the main power supply is a pulse signal.

Upon receiving a pulse signal, receiving element 410 sends the pulse signal to decoding element 420. In one embodiment, decoding element 420 is configured to recognize if the pulse signal is a signal for activating main power supply 440. If the signal is not for activating main power supply 440, it is ignored.

In one embodiment, decoding element 420 comprises a log amplifier and a decoder. The log amplifier detects the pulse signal and conditions the signal for use by a decoder. The log amplifier then sends the pulse signal to the decoder. The decoder operates to sample and hold the pulse signal. The decoder is configured to recognize if the pulse signal is a signal for activating main power supply 440. If the signal is not for activating main power supply 440, it is ignored.

Upon determination that the signal from the cable or satellite provider is to activate main power supply 440, decoding element 420 will send an activation signal along activation line 470 to main power supply 440. This activation signal operates to activate main power supply 440. Upon receiving the activation signal, main power supply 440 is activated. Hence, set-top box switches from standby power mode to active power mode.

In one embodiment, decoding element 420 also sends an activation signal along activation line 470 to main circuitry 450. In the present embodiment, system architecture may require an activation signal in addition to power to activate main circuitry 450. Upon receiving both the activation signal and power from main power supply 440, main circuitry 450 is activated. Hence, set-top box switches from standby power mode to active power mode.

As described above, a cable or satellite provider can interact with main circuitry 450 when set-top box 400 is in active mode. Receiving element 410 is coupled to main circuitry 450 over a connection for transmitting electron data (e.g. a wire). Receiving element 410 receives externally generated information (e.g. software downloads, polling requests) and transmits the information to main circuitry 450. Upon receiving the information, main circuitry interprets the information and allocates it or responds to it as desired.

Upon the completion of receiving externally generated information, main circuitry 450 determines whether or not a user has interacted(e.g. began to watch television, changed channels, adjusted the volume) with set-top box 400 in the period between the set-top box entering active mode and the completion of receiving the information. If a user has not interacted with set-top box 400, main circuitry 450 sends a deactivation signal to main power supply 450. Upon receiving the deactivation signal, main power supply 450 deactivates, returning set-top box 400 to standby mode. Conversely, if a user has interacted with set-top box 400, main circuitry 450 does not send a deactivation signal so as not to interrupt the user's viewing.

FIG. 5 is a flowchart showing the steps in a process 500 for remote access of the power control system of a set-top box (e.g. set-top box 400 of FIG. 4) in accordance with one embodiment of the present invention. The set-top box is configured for receiving broadcast signals and other externally generated signals transmitted by a cable or satellite provider over broadcast channels and out-of-band channels and for decoding those signals. The set-top box operates in two power modes, an “active” mode and a “standby” mode.

At step 510 of process 500, the set-top box receives a signal from a cable or satellite provider. In one embodiment, the signal is received at a receiving element (e.g. receiving element 410 of FIG. 4). In one embodiment, the receiving element is a radio frequency input amplifier. In another embodiment, the receiving element is configured to receive signals over a terrestrial connection (e.g. coaxial cable). In another embodiment, the receiving element is configured to receive signals over a satellite connection. In another embodiment, the receiving element is configured to receive signals over a telephone line. In another embodiment, the receiving element is configured to receive signals over a power line.

The receiving element is coupled to a standby power supply. When the set-top box is operating in standby mode, the standby power supply operates to provide sufficient power to the receiving element.

While operating in standby mode, the receiving element may receive any number of signals over broadcast and out-of-band channels at. In one embodiment, the cable or satellite provider will transmit a signal for activating the main power supply. This signal can take any form, and can be transmitted over any broadcast or out-of-band channel. In one embodiment, the signal for activating the main power supply is a pulse signal.

In one embodiment of the present invention, the signal received at the receiving element must be decoded, as shown at step 520. In one embodiment, upon receiving a pulse signal, the receiving element sends the pulse signal to a decoding element (e.g. decoding element 420 of FIG. 4). In one embodiment, the decoding element is configured to recognize if the pulse signal is a signal for activating the main power supply.

In one embodiment, the decoding element comprises a log amplifier and a decoder. The log amplifier detects the pulse signal and conditions the signal for use by a decoder. The log amplifier then sends the pulse signal to the decoder. The decoder operates to sample and hold the pulse signal. The decoder is configured to recognize if the pulse signal is a signal for activating the main power supply.

The decoding element is coupled to a standby power supply. When the set-top box is operating in standby mode, the standby power supply operates to provide sufficient power to the decoding element.

At step 530, it is determined whether the signal is for the purpose of activating the main power supply of the set-top box. If the signal is not for activating the main power supply of the set-top box, as shown at step 540 or process 500, the signal is ignored. Inversely, if the signal is for the activating the main power supply, as shown at step 550, the main power supply is activated. Upon activating the main power supply, the main circuitry becomes active.

In one embodiment, the decoding element will send an activation signal to the main power supply. This activation signal operates to activate main power supply. Upon receiving the activation signal, the main power supply is activated. Hence, the set-top box switches from standby power mode to active power mode.

In another embodiment, the decoding element sends an activation signal to both the main power supply and the main circuitry. In the present embodiment, system architecture may require an activation signal in addition to power to activate the main circuitry. Upon receiving both the activation signal and power from the main power supply, the main circuitry is activated. Hence, the set-top box switches from standby power mode to active power mode.

At step 560 of process 500, the cable or satellite provider interacts with the main circuitry. When the set-top box is operating in active mode, the cable or satellite operator will transmit externally generated information to the main circuitry. The cable or satellite provider might transmit signals to perform system maintenance, software downloads, and program information downloads. Also, the cable or satellite provider may transmit emergency messages or poll the set-top box. Polling is a process by which a provider can check the physical location of a specific set-top box to ensure that it is in the proper location.

Upon the completion of receiving externally generated information, as shown at step 570, the main circuitry determines whether a user has user has interacted (e.g. began to watch television, changed channels, adjusted the volume) with set-top box in the period between the set-top box entering active mode and the completion of receiving the information.

If a user has not interacted with the set-top box, as shown at step 590, the main power supply deactivates, returning the set-top box to standby mode. Conversely, if a user has interacted with the set-top box, as shown at step 580, the main power supply remains active so as not to interrupt the user's viewing.

Thus, embodiments of the present invention provide for a method and a device for permitting a set-top box to operate in a low power mode. The present invention also provides for a method and a device that permits cable and satellite operators to activate the main power supply of set-top box from a remote location, permitting them to access the main circuitry of the set-top box. Thus, the present invention provides for a system and a device that permits set-top box manufacturers to manufacture set-top boxes that satisfy both the requirements of the EPA and the requirements of cable and satellite providers.

The preferred embodiment of the present invention, a method and device for remote access of power control system of a set-top box allowing for a cable or satellite operator to activate the main power supply of a cable box from a remote location, is thus described. While the present invention has been described in particular embodiments, it should be appreciated that the present invention should not be construed as limited by such embodiments, but rather construed according to the below claims.

What is claimed is:

1. A method of remote access of standby power control, said method comprising the steps of:
a) receiving an externally generated signal at a set-top box, said set-top box configured for receiving broadcast signals, said externally generated signal transmitted over a broadcast channel, said set-top box comprising a standby power supply, a main power supply, and main circuitry;
b) provided said externally generated signal is for activating said main power supply, activating said main power supply in response to step a), wherein said step of activating said main power supply operates to provide power to said main circuitry.

2. The method as recited in claim 1 further comprising the step of decoding said externally generated signal to determine whether said externally generated signal is for activating said main power supply.

3. The method as recited in claim 1 wherein said set-top box comprises a receiving element, said receiving element configured to receive said externally generated signal, said receiving element coupled to said standby power supply and further comprising the step of said standby power supply providing power to said receiving element when said main power supply is not active.

4. The method as recited in claim 3 wherein said riving element is a radio frequency input amplifier.

5. The method as recited in claim 3 wherein said receiving element is configured to receive signals over a terrestrial connection.

6. The method as recited in claim 3 wherein said receiving element is configured to receive signals over a satellite connection.

7. The method as recited in claim 3 wherein said receiving element is configured to receive signals over a telephone line.

8. The method as recited in claim 3 wherein said receiving element is configured to receive signals over a power line.

9. The method as recited in claim 2 wherein said set-top box comprises a decoding element, said decoding element configured to decode said externally generated signal, said decoding element coupled to said standby power supply and further comprising the step of said standby power supply providing power to said decoding element when said main power supply is not active.

10. The method as recited in claim 9 wherein said decoding element is a log amplifier.

11. The method as recited in claim 10 wherein said log amplifier is configured for conditioning said signal.

12. The method as recited in claim 9 wherein said decoding element is configured to sample and hold said signal.

13. The method as recited in claim 1 further comprising the step of receiving externally generated information wherein said externally generated information is configured for use by said main circuitry.

14. The method as recited in claim 13 wherein said externally generated information comprises program information.

15. The method as recited in claim 13 wherein said externally generated information comprises at least one emergency alert.

16. The method as recited in claim 13 wherein said externally generated information comprises at least one software upgrade.

17. The method as recited in claim 13 wherein said externally generated information comprises a polling request.

18. The method as recited in claim 13 further comprising the step of upon the completion of receiving externally generated information, determining whether a user has interacted with said set-top box in the time period since said main circuitry has been activated.

19. The method as recited in claim 18 further comprising the step of provided a user has not interacted with said set-top box in the time period since said main circuitry has been activated, deactivating said main power supply.

20. A set-top box for receiving broadcast signals, said set-top box comprising:
a receiving element for receiving an externally generated signal, said externally generated signal transmitted over a broadcast channel;
a standby power supply coupled to said receiving element wherein said standby power supply provides sufficient power for operation of said receiving element provided a main power supply of said set-top box is not active;
main circuitry for interpreting data received over broadcast channels; and
said main power supply coupled to said main circuitry and wherein activating said main power supply operates to provide power to said main circuitry, wherein provided said signal is for activating said main power supply, said main power supply is activated in response to said signal.

21. The set-top box as recited in claim 20 further comprising a decoding element for recognizing a signal for activating a main power supply, said decoding element coupled to said standby power supply wherein said standby power supply provides power to said decoding element.

22. The set-top box as recited in claim 20 wherein said receiving element is a radio frequency input amplifier.

23. The set-top box as recited in claim 20 wherein said receiving element is configured to receive signals over a terrestrial connection.

24. The set-top box as recited in claim 20 wherein said receiving element is configured to receive signals over a satellite connection.

25. The set-top box as recited in claim 20 wherein said receiving element is configured to receive signals over a telephone line.

26. The set-top box as recited in claim 20 wherein said receiving element is configured to receive signals over a power line.

27. The set-top box as recited in claim 21 wherein said decoding element is a log amplifier.

28. The set-top box as recited in claim 27 wherein said log amplifier is operable to condition said externally generated signal.

29. The set-top box as recited in claim 21 wherein said decoding element is operable to sample and hold said externally generated signal.

30. The set-top box as recited in claim 20 wherein said receiving unit is operable to receive externally generated information wherein said externally generated information is configured for use by said main circuitry.

31. The set-top box as recited in claim 30 wherein said externally generated information comprises program information.

32. The set-top box as recited in claim 30 wherein said externally generated information comprises at least one emergency alert.

33. The set-top box as recited in claim 30 wherein said externally generated information comprises at least one software upgrade.

34. The set-top box as recited in claim 30 wherein said externally generated information comprises a polling request.

35. The set-top box as recited in claim 30 wherein upon the completion of receiving said externally generated information, provided a user has not interacted with said set-top in the time period between said main circuitry has been activated and said completion of receiving said externally generated information, said main power supply is deactivated.

36. A set-top box for receiving broadcast signals, said set-top box comprising:
a receiving element for receiving an externally generated signal, said externally generated signal transmitted over a broadcast channel, said receiving unit is operable to receive externally generated information wherein said externally generated information is configured for use by main circuitry;
a decoding element for recognizing a signal for activating a main power supply;
a standby power supply coupled to said receiving element and said decoding element wherein said standby power supply provides sufficient power for operation of said receiving element and said decoding element when a main power supply of said set-top box is not active;
said main circuitry for interpreting data received over broadcast channels; and
said main power supply coupled to said main circuitry wherein activating said main power supply operates to provide power to said main circuitry, wherein provided said signal is for activating said main power supply, said main power supply is activated in response to said signal, wherein upon the completion of receiving said externally generated information, provided a user has not interacted with said set-top in the time period since said main circuitry has been activated, said main power supply is deactivated.
